(19) United States
(12) Patent Application Publication
(10) Pub. No.: US 2003/0235053 A1
(43) Pub. Date: Dec. 25, 2003

(54) Seasonal light strand hanger

(76) Inventor: Bradley J. Jones, Austin, TX (US)

Correspondence Address: BLACKWELL SANDERS PEPER MARTIN LLP, TWO PERSHING SQUARE, 2300 MAIN STREET, SUITE 1000, KANSAS CITY, MO, 64108, US

(21) Appl. No.: 10/177,447

(22) Filed: Jun. 21, 2002

(51) Int. Cl. F21V 21/00

(52) U.S. Cl. 362/396; 362/249; 362/147; 362/252

(57) ABSTRACT

A holiday lights strand hanger (18), having a clip arm (20), cylindrical hinge (24) and mounting plate (32), is utilized to mount holiday lights on a building year-round which can be moved from a storage position behind a facia board (16) to a display position below the facia board (16). The clip arm (20) holds the wire portion of a strand of holiday lights. The clip arm (20) is attached to the cylindrical hinge (24) and can be moved between the display position and the storage position by rotating the hinge (24). The hinge (24) is connected to a mounting plate (32) attached to the facia board.

### FIELD OF THE INVENTION

This invention relates to devices for hanging lights attached to and spread over the length of a wire and, more particularly, to a hanger for strands of seasonal lights typically mounted to a dwelling.

### BACKGROUND OF THE INVENTION

Holiday lights are a very popular and lucrative element of seasonal celebrations, and their popularity persists despite their effort-intensive and time consuming hanging requirements. Typically, the lights are attached to the home along the outline of the roof or other unique architectural features.

Holiday lights generally come as part of a wire strand, with the light bulbs hanging from the wire. The lights are attached to the house by clipping, nailing, stapling, or gluing the wire onto the house itself. In order to attach the light strands in a manner that outlines the roof, the lights must be attached along the eaves or the facia board. Because the desired location for attaching the lights is near the roof, the holiday light hanger typically uses a ladder or climbs on the roof to reach the proper place for affixing the lights.

The above requirements often result in a handyman-ballet where the fearless light hanger climbs a ladder with strand of lights and staplegun in hand. The light hanger must balance precariously on a ladder while simultaneously positioning the light strand for optimum aesthetic appeal and attaching the light strand to the house without toppling to the ground. The light hanger must then descend the ladder to reposition the ladder and properly attach the remaining portions of the light strand to the house.

In addition to the hassles described above, Holiday Light Etiquette, and many homeowner association contracts, place further demands and strains on the light hanger. Holiday lights cannot be left attached to the home year round; they must be removed after the holiday season has ended. This further requirement brings an entirely new set of hassles: the lights must be removed, the lights must be stored for the next holiday season, the lights must be examined for defects, and then re-attached in the Fall. This frustrating cycle continues each year.

Prior attempts to remedy this situation and save light hangers from the frustrating light-hanging-cycle have focused primarily on large metal or plastic housing units, with lights installed, that are permanently attached to the house under the roof. These housing units must be mounted onto the house and are generally large and cumbersome. The pre-fabricated housings are also disadvantageous because they only fit certain home designs and do not easily adapt to different architectural features. These housing units can hold anywhere from ten lights to an entire strand of lights. The lights are exposed either by opening a door on the front of the housing or keeping the lights on a rotatable plate that can be moved to expose the lights.

### BRIEF SUMMARY OF THE INVENTION

There is, therefore, provided in the practice of the invention a novel device for hanging strands of seasonal lights, which can be left attached to the house year-round, for nearly hassle free holiday light ornamentation. The seasonal light strand hanger broadly includes a clip for holding the light strand wire, and the clip is attached to an arm that is hingably connected to a mounting plate.

In a preferred embodiment, the wire holding clip consists of two crescent shaped wire receiving structures, or clip heads, attached to the clip arm for holding the light strand wire. The clip heads have an opening opposite the clip arm and each other that allows the light strand wire to enter the selected wire receiving area defined by the clip head. The clip arm is a substantially straight structure extending from the clip heads to a cylindrical hinge. The cylindrical hinge is a cylinder with ridges along the outer surface of the cylinder. The ridges on the cylindrical hinge engage a locking projection of the mounting plate to hold the hinge in position. Attachment arms, extending in opposite directions from the cylindrical hinge, pivotally connect the cylindrical hinge to the mounting plate. Thus, the cylindrical hinge can rotate substantially freely around the axis of the attachment arms while the locking projection is operable to hold the hinge in a desired location. The mounting plate defines the attachment arm receiving area for connecting the attachment arms to the mounting plate. The mounting plate also has a mounting guide extending perpendicular to the mounting plate for positioning the mounting plate on the facia board. A mounting plate aperture allows the mounting plate to be fastened to the facia board.

Accordingly, it is an object of the present invention to provide an improved holiday light strand hanger for mounting holiday light strands to a structure.

### BRIEF DESCRIPTION OF THE DRAWINGS

These and other inventive features, advantages, and objects will appear from the following Detailed Description when considered in connection with the accompanying drawings in which similar reference characters denote similar elements throughout the several views and wherein:

FIG. 1 is a side view of the seasonal light strand hanger according to the present invention;

FIG. 2 is the same side view as shown in FIG. 1, but with the device shown attached to a vertical face angled facia board;

FIG. 3 is a top view of a cylindrical hinge component of the seasonal light strand hanger of FIG. 1;

FIG. 4 is a side view of a mounting plate component of the seasonal light strand hanger of FIG. 1;

FIG. 5 is a top view of the mounting plate component of FIG. 4, and;

FIG. 6 is a bottom view of the mounting plate component of FIG. 4.

### DETAILED DESCRIPTION

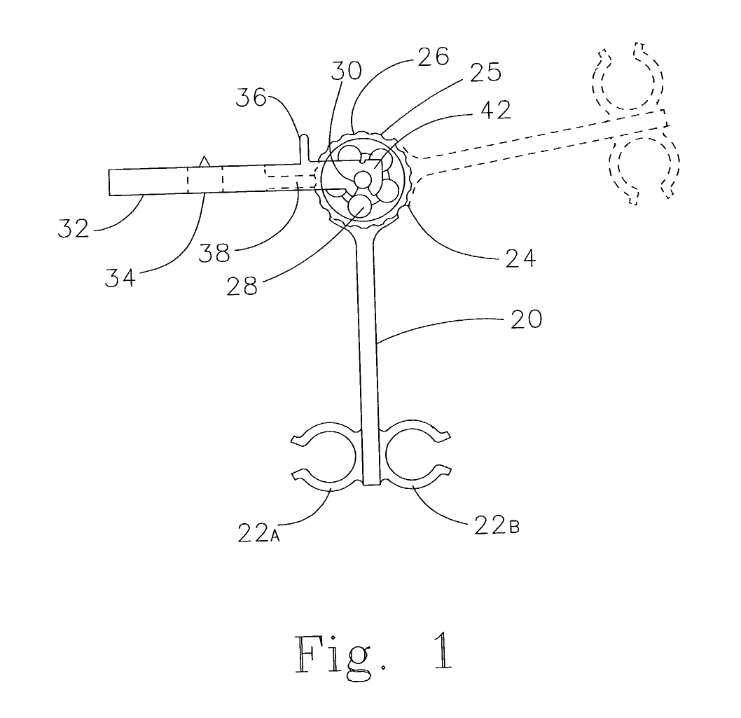

Referring to the drawings in greater detail, FIG. 1 shows a light strand hanger 18 constructed in accordance with a preferred embodiment of the present invention. The light strand hanger 18 broadly includes a clip arm 20, cylindrical hinge 24, and mounting plate 32. The mounting plate 32 attaches the light strand hanger 18 to a facia board 16 of a dwelling (not shown). The clip arm 20 grasps a wire portion of a holiday light strand holding it in position. The cylindrical hinge 24 allows the home owner to move the light strand from a storage position behind the facia board 16 to the display position below the facia board 16.

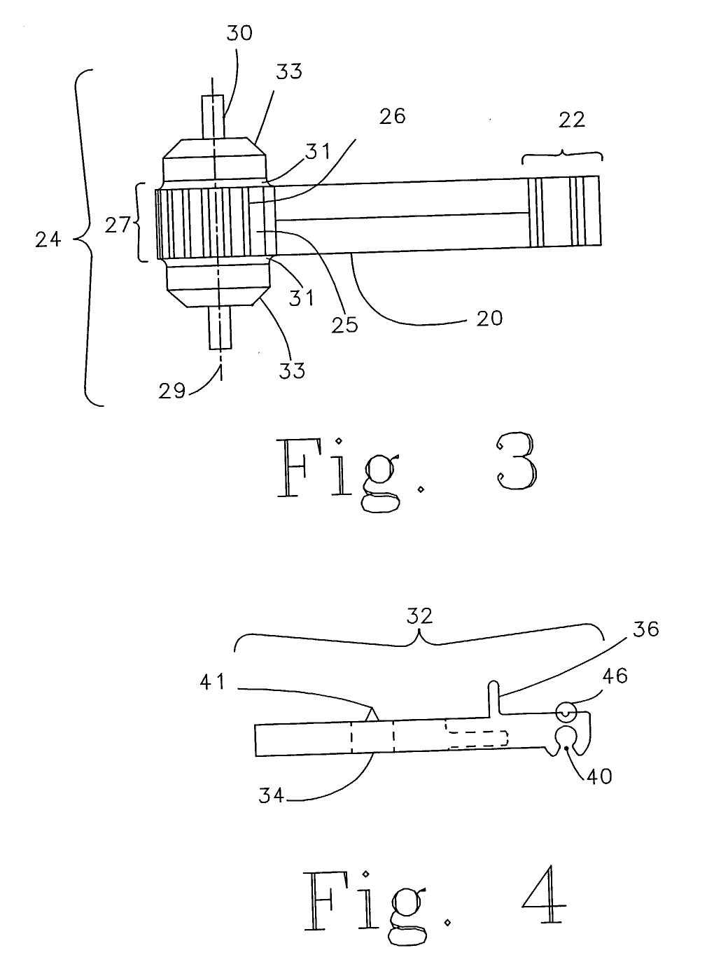

The clip arm 20, as shown in FIGS. 1 and 3, comprises two substantially identical clips 22 defining wire receiving areas for holding the holiday light strand wire. The clips are crescent shaped, with each opening to the wire receiving areas facing away from the clip arm 20. The clips are integrally molded with the clip arm 20. The clips 22 are positioned proximate to a free end 21 of the clip arm 20, with one clip attached to the top side of the clip arm and the other clip attached to the bottom side of the clip arm. Thus, the top and bottom clips 22A and 22B are positioned on opposite sides of the clip arm and have openings in opposite directions. The dual clips allow the light hanger to position the light strand wire either behind the clip arm or in front of the clip arm. The light hanger will also have the option of hanging two strands of lights on the same light strand hanger. Further, for added stability, the light hanger can wrap the strand of lights around the clip arm 20, through both clips 22. Alternatively, the clips 22 are staggered along the length of the clip arm. This dual clip arrangement gives the light hanger greater flexibility. In another embodiment, the clip arm can have multiple clips. The clip arm 20 is a substantially rigid structure extending from and fixedly attached to the cylindrical hinge 24.

The cylindrical hinge 24, as show in FIGS. 1 and 3, is a cylindrical structure having a rotating center cylinder 27, two pivoting attachment arms 30 and rounded ridges 26. The cylindrical hinge rotates around the axis 29 of the pivoting attachment arms 30. The cylindrical hinge is integrally molded with the clip arm 20, and the cylindrical hinge is pivotally attached to the mounting plate 32 by the pivoting attachment arms 30.

The cylindrical hinge has between approximately fifteen and thirty ridges 26 on the outer surface of the center cylinder 27 running parallel to the attachment arm 30 axis 29. The ridges 26 extend across the middle of the outer surface of the cylinder, and are generally evenly spread around the entire circumference of the center cylinder 27. The ridges are rounded with a channel 25 between each ridge. The ridges and channels form catch areas for a locking projection 38. When the locking projection 38, which is also rounded and slightly flexible, passes over a ridge and slips into a channel, the cylindrical hinge stops rotating. If the cylindrical hinge does not rotate, the clip arm also does not move, thereby holding a light strand wire in either the display or storage position relative to a facia board. The cylindrical hinge maintains a stable position until the light hanger exerts gentle pressure on the clip arm to move the locking projection out of its present channel and into a new one. The rounded shape of the ridges and locking projection allows the locking projection to move smoothly from one channel to the next. Generally, the space between the ridges, that is the channels, are substantially equal to the widths of the locking projection. The hinge 24 and clip arm 20 can rotate approximately 270° to provide a broad range of motion and many mounting positions.

The cylindrical hinge also has the pivoting attachment arms 30. The pivoting attachment arms are also cylindrically shaped and extend out from the center cylinder 27 along the axis of the cylinder. The pivoting attachment arms have smaller diameters than the center cylinder. The cylindrical hinge also includes inner tapered shoulders 31 and outer tapered shoulders 33. They make attachment of the cylindrical hinge to the mounting plate easier. The tapering helps guide the cylindrical hinge into the proper position between mount legs 42 of the mounting plate 32, thereby aligning the pivoting attachment arms with the attachment arm receiving areas 40, for easy connection of the cylindrical hinge to the mounting plate.

The cylindrical hinge also has five pores 28 running through the center cylinder 27 parallel to the axis of the pivoting attachment arms 30 and the ridges. The pores 28 are positioned outwardly from the attachment arms 30, and these pores 28 allow the center cylinder 27 to flex inwardly as the hinge pivots and the locking projection 38 passes over the ridges 26. Thus, the pores 28 reduce the amount of force required to dislodge the locking projection from the channels and pivot the hinge. Further, the pores 28 reduce the material required for manufacturing.

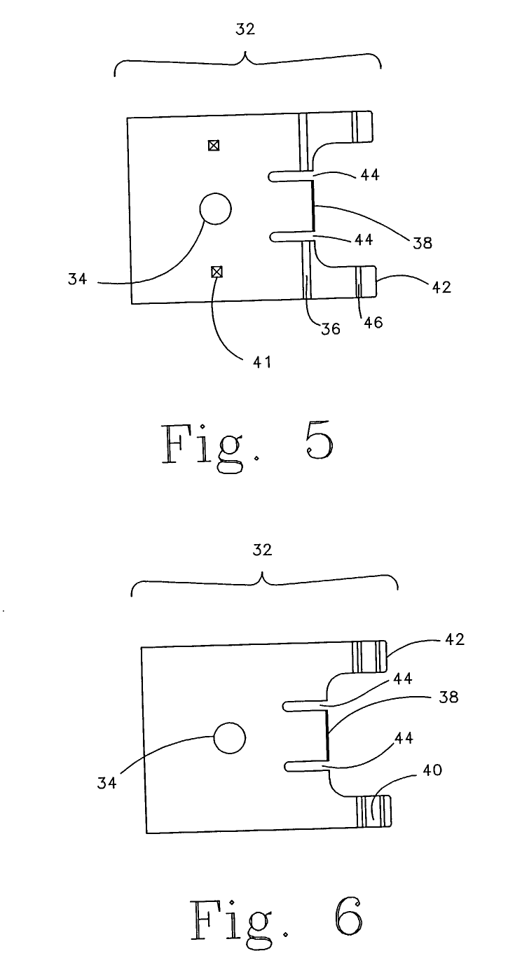

The mounting plate 32, as shown in FIGS. 4 and 5, having a mounting aperture, locking projection and mount legs with receiving areas for pivoting attachment arms, fixes the seasonal light strand hanger 18 to the facia board 16. The mounting plate 32 has a flat bottom surface with a mounting aperture 34 for attaching the mounting plate to the facia board. In one embodiment, the mounting aperture is a hole with straight sides for fastening to the facia board 16 with a fastener such as a nail 14. In another embodiment, the mounting aperture has a slight bevel towards the bottom side of the mounting plate, allowing for properly fastening the mounting plate to a facia board using a beveled screw that will mate with the beveled aperture, so that the screw is recessed below or flush with the mounting plate surface. Other methods for attaching the mounting plate to a structure may be used, such as self-applied or pre-applied adhesive. The adhesive may also be used as a temporary hold while the fastener is attached to the facia board 16 through the mounting aperture. The mounting aperture is centered in the mounting plate to provide a suitable location for nailing the mounting plate to a structure.

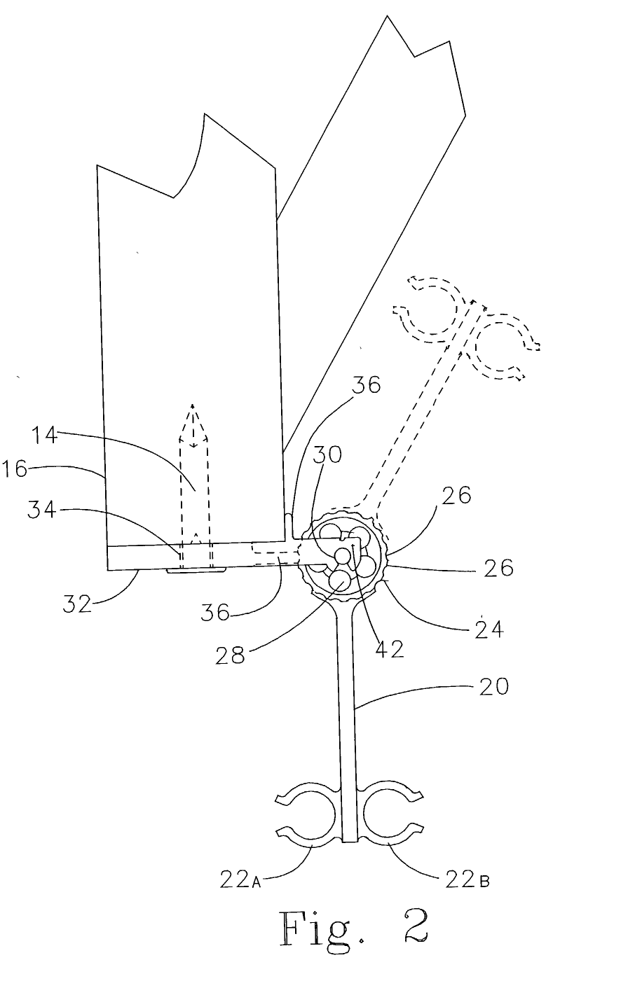

The mounting plate 32, in one embodiment, has two mounting teeth 41 on the top side of the mounting plate. The mounting teeth are located on each side of the mounting aperture 34, although they could be positioned anywhere on the top side of the mounting plate. The teeth project slightly above the surface of the mounting plate and fasten to the facia board 16 when the mounting plate is attached. The teeth prevent the mounting plate from rotating around a central fastener, such as a nail 14, as shown in FIG. 2.

The substantially rigid mounting plate 32 also forms the locking projection 38 that engages the cylindrical hinge 24, specifically channels 25 of the cylindrical hinge 24. The locking projection is located on the end of the mounting plate closest to the cylindrical hinge 24 component and is substantially co-planer with the plate. The locking projection is formed at the center of the edge of the mounting plate with two open relief areas 44 on either side of the projection. The relief areas 44 allow the projection to flex up and down relative to the rest of the plate. The two mount legs 42 of the mounting plate flank the locking projection. The locking projection interacts with the channels 25 of the cylindrical hinge 24 to prevent the cylindrical hinge from rotating. The locking projection is flexible enough to bend slightly as it,passes over the ridges 26 of the cylindrical hinge and has a rounded distal end 35 to make that passage easier.

The top of the mounting plate 32 has a mounting guide 36 protruding perpendicular from the mounting plate. The mounting guide 36, as shown in FIG. 4, is placed behind the attachment arm receiving areas 40, to provide the correct placement of the mounting plate on the facia board 16. The mounting guide allows the light hanger to position the mounting plate so that the clip arm 20 will not be hindered in its rotation by the facia board. As shown in FIG. 2, the clip arm will rotate with the cylindrical hinge to position the clips 22 behind the facia board. If the mounting plate were fastened too far forward on the facia board, the clip arm could not swing freely into the storage position because the clip arm would hit the facia board. The mounting guide ensures the clip arm can rotate free of the facia board. The mounting guide also aids the light hanger when fastening the mounting plate. In one embodiment, the mounting plate is nailed into the facia board. The mounting guide allows the light hanger to hold the mounting plate from the side, exerting pressure at a 45° angle. The mounting guide prevents the mounting plate from slipping sideways due to the horizontal pressure. Therefore, the light hanger can hold the mounting plate away from the mounting aperture without moving the mounting plate while trying to hammer in a nail. This holding location is safer for the light hanger's fingers.

The two mount legs 42 define the attachment arm receiving areas 40 for receiving the pivoting attachment arms 30. The mount legs are smooth and flat on the top, with a slight indentation 46 near the end of the mount legs 42, as shown in FIG. 4. This indentation 46 allows the mount legs 42 to flex slightly when attaching the pivot attachment arms 30. The mount legs also form the generally U-shaped receiving areas 40 recessed into the mount legs from the bottom, with slight protrusions on either end of the “U” on the bottom side of the mounting plate. The receiving areas are shaped to fit around the cylindrical shape of the pivoting attachment arms. In one embodiment, the pivoting attachment arms can be snapped in and out of the receiving areas in the mount legs, making the cylindrical hinge detachable from the mounting plate. In another embodiment, the receiving area 40 encloses the pivoting attachment arm, preventing the cylindrical hinge from being removed.

In one embodiment, the hangers are manufactured using a plastic capable of withstanding outdoor conditions, particularly ultraviolet exposure, climate variations, and precipitation. The hangers 18 can be manufactured in different colors selected to match colors commonly chosen for facia boards.

In operation, a light hanger will fasten a plurality of the hangers 18 to the facia board 16 or other components of a structure, which is typically a family dwelling such as a house or apartment. With the hangers 18 in place, the person hanging the light then inserts one or more strands of lights into the desired clip 22. Assuming that the first installation occurs at the beginning of the holiday season, the light hanger would position the clip arms in a display position as the wire was inserted in the clips. After the holiday season, the light hanger will, instead of removing the hangers 18, apply gentle pressure to the clip arm forcing the locking projection to ratchet through the channels defined between the ridges 26 of the center cylinder 27. The light hanger would continue to rotate the clip arm and hinge 24 until the clip arm and light strand (not shown) are in the desired storage position.

When the holiday season arrives again, the light hanger simply rotates the hinge 24 and clip arm 20 until the lights are again in the desired display position. Thus, the locking projection selectively engages the ridges to hold the hinge in a desired position for either storage or display. If the light hanger wants to use lights for different holidays with contrasting light colors, such as Halloween and Christmas, an orange strand of lights is held in one set of the clips, and a red and green strand of lights is held in the set of other clips. The light hanger simply deploys the clip arm and supplies power to the desired strand of lights for the appropriate season. The second clip could alternatively hold icicle-style holiday lights. When the holiday season was complete, the light hanger could wrap the icicle-style holiday lights around the clips of the clip arm before moving the clip arm into the storage position behind the facia board.

The seasonal light strand hanger 18 according to the present invention provides a simple, adaptable system for year-round mounting of holiday light strands to a building. The seasonal light strand hanger is easy to attach to a building and adapts to almost any shape or architectural feature of a building. The present invention allows holiday lights to be moved between a storage position hidden behind a facia board to a display position located below the facia board, eliminating the need to remove and replace the lights each holiday season.

Thus, a holiday light strand hanger is disclosed which utilizes a hinged clip arm to move holiday lights between a storage position and a display position, thereby allowing the light strands to be mounted on a building year-round instead of only during the holiday season. While preferred embodiments and particular applications of this invention have been shown and described, it is apparent to those skilled in the art that many other modifications and applications of this invention are possible without departing from the inventive concepts herein. For example, the mounting plate could be fastened to the facia board using glue or staples instead of the mounting aperture, and the hanger could be used for something other than lights. It is, therefore, to be understood that, within the scope of the appended claims, this invention may be practiced otherwise than as specifically described, and the invention is not to be restricted except in the spirit of the appended claims. Though some of the features of the invention may be claimed in dependency, each feature has merit if used independently.

What is claimed is:

1. A device for hanging light strands, the device comprising:
a substantially rigid mounting plate suitable for fastening to a structure;
a cylindrical hinge pivotally connected to the mounting plate;
a clip arm extending from the cylindrical hinge, and the clip arm having a free end spaced from the cylindrical hinge; and
a wire holding structure attached proximate to the free end of the clip arm.

2. The device according to claim 1 wherein the wire holding structure comprises a crescent-shaped wire receiver for receiving a wire.

3. The device according to claim 1 wherein the wire holding structure comprises two substantially identical clips attached to opposite sides of the clip arm.

4. The device according to claim 1 wherein the clip arm is fixedly attached to the surface of the cylindrical hinge.

5. The device according to claim 1 wherein the surface of the cylindrical hinge has ridges extending parallel to the axis of the cylindrical hinge.

6. The device according to claim 5 wherein the mounting plate comprises a locking projection, selectively engaging the ridges to hold the hinge in a desired position.

7. The device according to claim 5 wherein the ridges are rounded.

8. The device according to claim 5 wherein the sides of the ridges slope into a channel between the ridges.

9. The device according to claim 1 wherein the mounting plate compromises a locking projection engaging the cylindrical hinge to hold the cylindrical hinge in position.

10. The device according to claim 1 wherein the cylindrical hinge includes attachment arms extending axially from the main body of the cylindrical hinge for pivotally connecting to the mounting plate.

11. The device according to claim 1 wherein the cylindrical hinge has pores extending through the cylinder parallel to the axis of the attachment arms.

12. The device according to claim 1 wherein the mounting plate comprises a mounting aperture extending through the mounting plate;
a mounting guide extending from the mounting plate for engaging the structure and aligning the mounting plate relative to the structure;
a locking projection operable to engage the cylinder hinge; and
receiving regions on the mounting plate for attaching the cylindrical hinge to the mounting plate.

13. A device for hanging light strands, the device comprising:
a clip arm attached to a cylindrical hinge;
a cylindrical hinge removably attached to a mounting plate; and
a mounting plate suitable for attachment to a facia board.

14. The device according to claim 13 wherein the mounting plate comprises a mounting aperture for attaching the mounting plate to a building.

15. The device according to claim 13 wherein the mounting plate comprises a mounting guide extending perpendicular to the mounting plate.

16. The device according to claim 13 wherein the cylindrical hinge comprises a series of ridges defining channels on the surface of the cylindrical hinge that run parallel to the axis of the cylinder.

17. The device according to claim 16 wherein the mounting plate comprises a locking projection extending away from the mounting aperture in the plane of the mounting plate and the locking projection being engagable in the channels.

18. The device according to claim 10 wherein the cylindrical hinge comprises two pivoting attachment arms along the axis of the cylinder extending out from the ends of the cylinder.

19. The device according to claim 10 wherein the mounting plate comprises two pivot arm receiving regions for attaching the pivoting attachment arms of the cylindrical hinge to the mounting plate.

20. A device for hanging light strands, comprising:
a clip arm for holding the light strand attached to a cylindrical hinge;
the cylindrical hinge removably attached to a mounting plate, the cylindrical hinge including:
a plurality of attachment arms extending along the axis of the cylindrical hinge; and
hinge surface ridges arranged parallel to the axis of the cylinder;
the mounting plate including:
a plurality of attachment arm receiving areas;
a mounting guide extending perpendicular to the mounting plate; and
a locking projection extending toward the cylindrical hinge.
